(19) United States
(12) Patent Application Publication
(10) Pub. No.: US 2023/0308167 A1
(43) Pub. Date: Sep. 28, 2023

(54) METHOD AND APPARATUS FOR PAUSING RADIO LINK FAILURE DETECTION FOR NON-TERRESTRIAL NETWORKS

(71) Applicant: LG Electronics Inc., Seoul (KR)

(72) Inventors: Oanyong LEE, Seoul (KR); Sunghoon JUNG, Seoul (KR)

(21) Appl. No.: 18/017,559

(22) PCT Filed: Jul. 30, 2021
(86) PCT No.: PCT/KR2021/009955

§ 371 Date: Jan. 23, 2023

(30) Foreign Application Priority Data
Jul. 31, 2020 (KR) 10-2020-0095630

(51) Int. Cl. H04B 7/185; H04W 24/08

(52) U.S. Cl. CPC H04B 7/18519; H04W 24/08

(57) ABSTRACT

A method and apparatus for pausing Radio Link Failure detection for Non-Terrestrial Networks is provided. A wireless device establishes a connection with a Radio Access Node (RAN) node. A wireless device initiating a Radio Link Failure (RLF) detection for the connection. A wireless device receives, from the RAN node, information on feeder link switching which informs that an NTN gateway for the RAN node is switched. A wireless device stops the initiated RLF detection based on the information on the feeder link switching.

### TECHNICAL FIELD

The present disclosure relates to a method and apparatus for pausing Radio Link Failure detection for Non-Terrestrial Networks.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems, 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Thanks to the wide service coverage capabilities and reduced vulnerability of space/airborne, vehicles to physical attacks and natural disasters, non-terrestrial networks (NTN) are expected to:
foster the roll out of 5G service in un-served areas that cannot be covered by terrestrial 5G network (isolated/remote areas, on board aircrafts or vessels) and underserved areas (e.g., sub-urban/rural areas) to upgrade the performance of limited terrestrial networks in cost effective manner,
reinforce the 5G service reliability by providing service continuity for machine-to-machine (M2M)/Internet-of-things (IoT) devices or for passengers on board moving platforms (e.g., passenger vehicles-aircraft, ships, high speed trains, bus) or ensuring service availability anywhere especially for critical communications, future railway/maritime/aeronautical communications, and to
enable 5G network scalability by providing efficient multicast/broadcast resources for data delivery towards the network edges or even user terminal.

### SUMMARY

During NTN operation, feeder link switching between different NTN gateways toward the same satellite could be performed. For example, the feeder link switching may occur because of system maintenance, data offloading, and/or movement by Low Earth Orbit (LEO) satellites. If an LEO satellite is moving out of visibility with respect to the current NTN gateway, the LEO satellite may find new NTN gateway to serve. This switching procedure may need to be performed without causing service disruption to the served UEs.

However, considering a large cell coverage size of NTN, it might be an extremely difficult for NTN gateway to send HO commands to the large number of served UEs via satellites respectively in a short time. For example, a part of UEs may not be able to perform handover or receive handover configuration in time. As a result, radio link failure may be detected for the part of UEs, and then UEs may need to perform a RRC restoring procedure.

Since it may take a long time to restore RRC connection, which may involve RLF detection, cell selection, and potential reestablishment failure, it may cause a problem with service continuity.

Therefore, studies for pausing Radio Link Failure detection for Non-Terrestrial Networks are required.

In an aspect, a method performed by a wireless device in a wireless communication system is provided. A wireless device establishes a connection with a Radio Access Node (RAN) node. A wireless device initiating a Radio Link Failure (RLF) detection for the connection. A wireless device receives, from the RAN node, information on feeder link switching which informs that an NTN gateway for the RAN node is switched. A wireless device stops the initiated RLF detection based on the information on the feeder link switching.

In another aspect, an apparatus for implementing the above method is provided.

The present disclosure can have various advantageous effects.

According to some embodiments of the present disclosure, a wireless device could efficiently pause Radio Link Failure detection for Non-Terrestrial Networks.

For example, a wireless device could relax the RLF condition temporarily, by receiving information from the network.

For example, a wireless device could avoid unnecessary RLF declaration or triggering re-establishment procedure can be avoided, by pausing the RLF detection temporarily.

According to some embodiments of the present disclosure, a wireless communication system could provide a solution for pausing Radio Link Failure detection for Non-Terrestrial Networks efficiently.

For example, when network expects that the radio link will be temporarily unavailable so that temporary RLF may occur, the network may inform wireless devices to relax the RLF detection condition temporarily.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 and FIG. 11 show typical scenarios of a non-terrestrial network providing access to user equipment to which implementations of the present disclosure is applied.

FIG. 12 shows an example of the feeder link switch for transparent LEO to which implementations of the present disclosure is applied.

FIG. 13 shows one possible solution to enable service continuity for feeder link switch to which implementations of the present disclosure is applied.

FIG. 14 shows another possible solution to enable service continuity for feeder link switch to which implementations of the present disclosure is applied.

FIG. 15 shows an example of a method for pausing Radio Link Failure detection for Non-Terrestrial Networks, according to some embodiments of the present disclosure.

FIG. 16 shows an example of a method for pausing Radio Link Failure detection for Non-Terrestrial Networks, according to some embodiments of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may he embodied through radio technology such as universal terrestrial radio access (UTRA) or CDMA2000. TDMA may be embodied through radio technology such as global system for mobile communications (GSM), general packet radio service (CPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCI-I” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

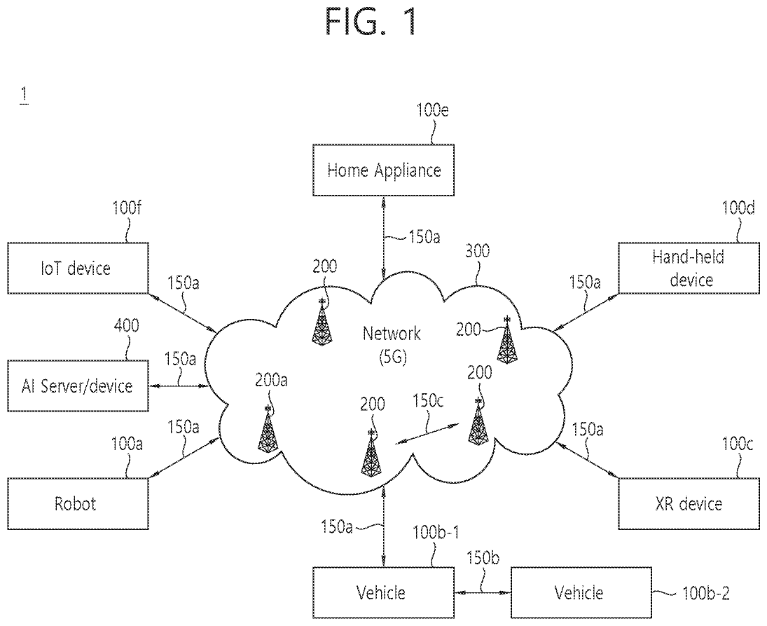

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/SG devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication) The IoT device (e.g., a sensor) may perform direct communication with other IoT devices (e.g., sensors or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit; receive radio signals to/from each other through the wireless communication connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may he implemented in at least one of the various specifications, such as 1) LIE Cat 0, 2) LIE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

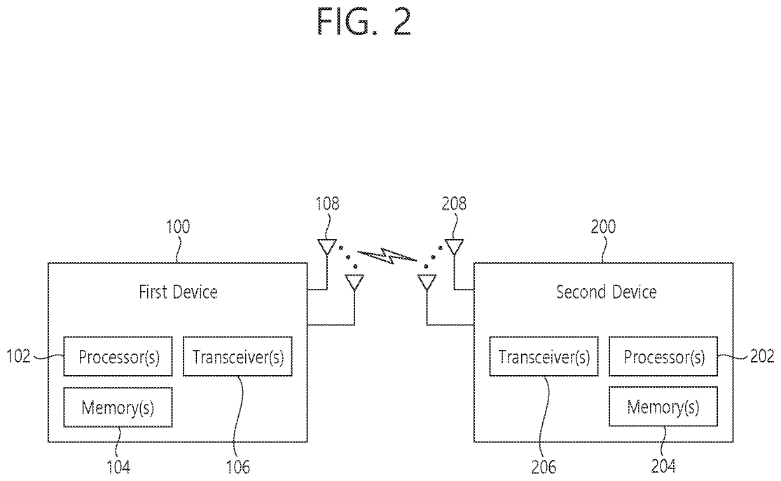

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR), In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may he configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

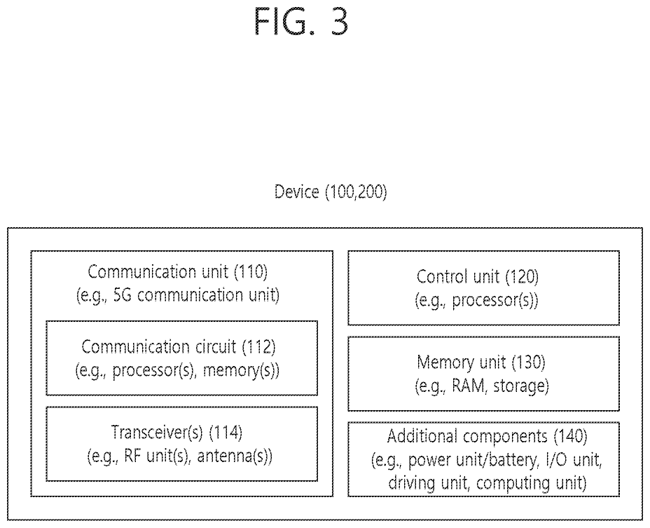

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion., and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

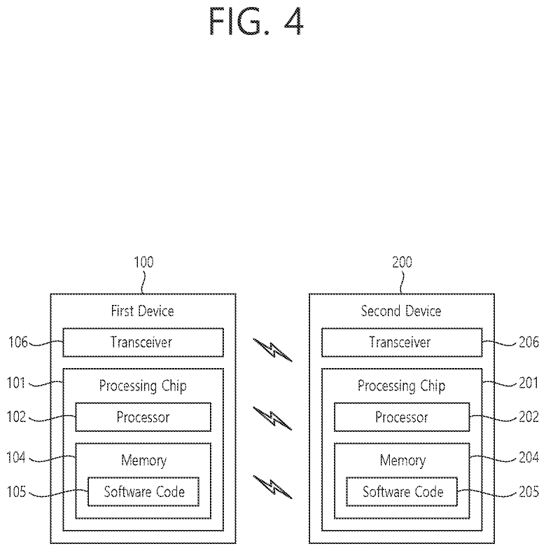

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols, For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

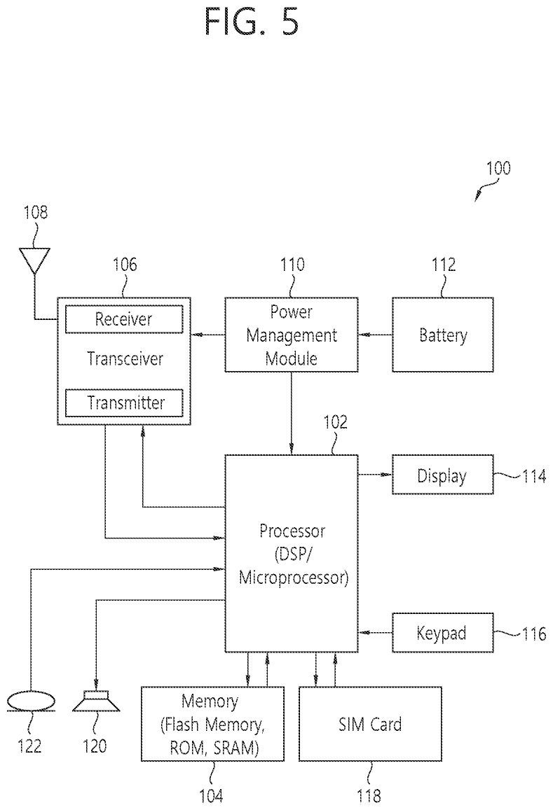

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®. A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in Which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

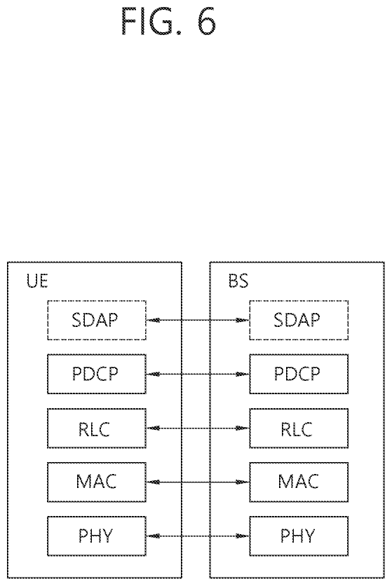

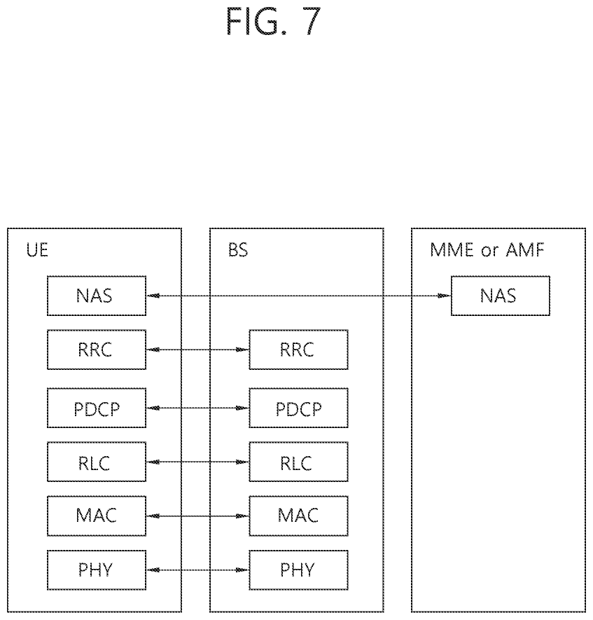

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PRY layer) and Layer 2. Referring to FIG. 7, the control plane protocol stack may be divided into Layer 1 (i.e., a PRY layer), Layer 2, Layer 3 (e.g., an RRC layer), and anon-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PRY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system; the main services and functions of the MAC sublayer include: mapping between logical channels and transport channels; multiplexing-de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical charnels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can he mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

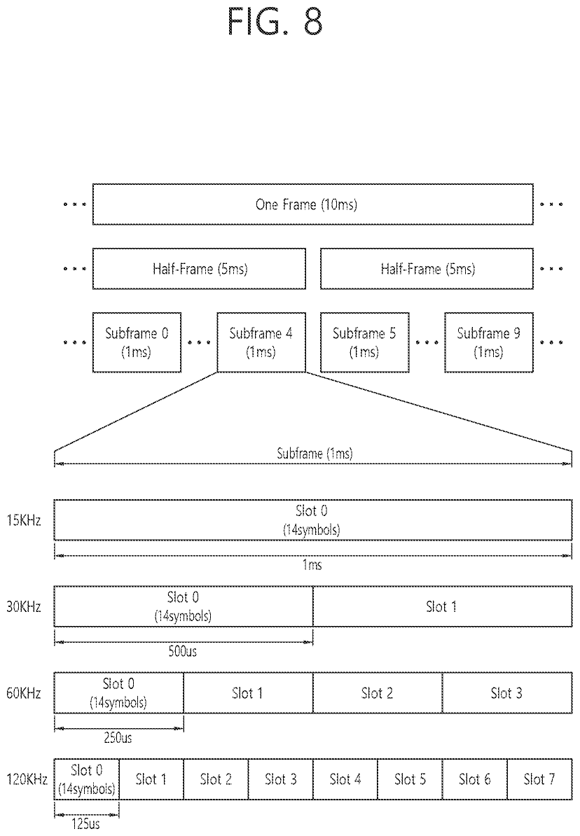

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication systern, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slats and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| μ | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| μ | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}ₛᵤ subcarriers and N^{subframe,u}_{symb} symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL, for downlink and UL for uplink. N^{RB}_{sc} is the number of subcarriers per RB. In the 3GPP based wireless communication system, N^{RB}_{sc} is 12 generally. There is one resource grid fir a given antenna port p, subcarrier spacing configuration u, and transmission direction (DL or UL). The carrier bandwidth N^{size,u}_{grid} for subcarrier spacing configuration a is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR. system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration a coincides with ‘point A’ which serves as a common reference point for resource block grids. In the 3GPP NR system, PRBs are defined within a bandwidth part (BWP) and numbered from 0 to N^{size}_{BWP,i}-1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth,

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | | |
|---|---|---|---|
| designation | range | Subcarrier Spacing | |
| FR1 | 450 MHz-6000 MHz | 15, 30, 60 | KHz |
| FR2 | 24250 MHz-52600 MHZ | 60, 120, 240 | KHz |

As mentioned above, the numerical value of the frequency range of the NR system may be changed. For example, FR1 may include a frequency band of 410MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | | |
|---|---|---|---|
| designation | range | Subcarrier Spacing | |
| FR1 | 410 MHz-7125 MHz | 15, 30, 60 | KHz |
| FR2 | 24250 MHz-52600 MHZ | 60, 120, 240 | KHz |

in the present disclosure, the term “cell” may refer to a geographic area to which one or more nodes provide a communication system, or refer to radio resources. A “cell” as a geographic area may be understood as coverage within which anode can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE RRC_CONNECTED configured with CA/DC, the term “serving cells” is used to denote the set of cells comprised of the SpCell(s) and all SCells. In DC, two MAC entities are configured in a UE: one for the MCG and one for the SCG.

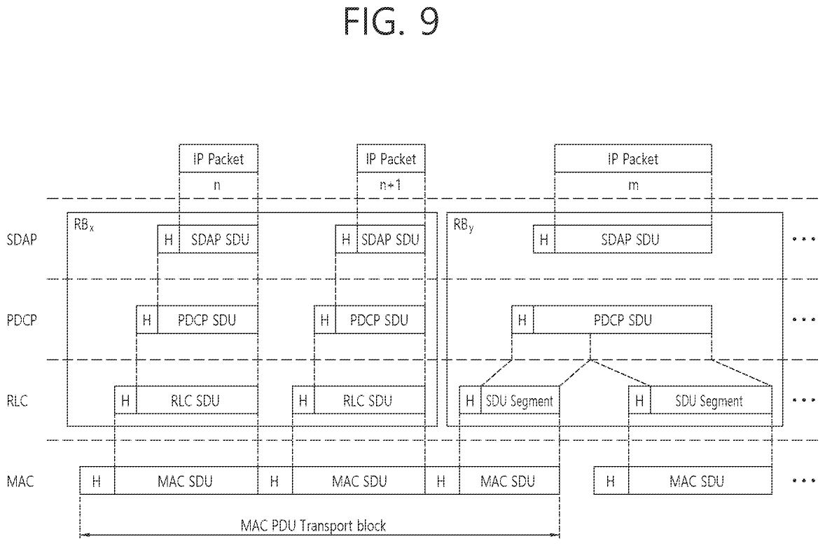

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, Radio link failure related actions are described. Section 5.3.10 of 3GPP TS 38.331 v16.0.0 may be referred.

Detection of physical layer problems in RRC_CONNECTED is described.

The UE shall:
1> if dapsConfig is configured for any DRB, upon receiving N310 consecutive “out-of-sync” indications for the source from lower layers while T304 is running:
2> start timer T310 for the source.
1> upon receiving N310 consecutive “out-of-sync” indications for the SpCell from lower layers while neither T300, T301, T304, T311 nor T319 are running
2> start timer T310 for the corresponding SpCell.

Recovery of physical layer problems is described.

Upon receiving N311 consecutive “in-sync” indications for the SpCell from lower layers while T310 is running, the UE shall:
1> stop timer T310 for the corresponding SpCell.
1> stop timer T312 for the corresponding SpCell, if running,

In this case, the UE maintains the RRC connection without explicit signalling, i.e. the UE maintains the entire radio resource configuration.

Periods in time where neither “in-sync” nor “out-of-sync” is reported by L1 do not affect the evaluation of the number of consecutive “in-sync” or “out-of-sync” indications.

Detection of radio link failure is described.

The UE shall:
1> if dapsConfig is configured for any DRB:
2> upon T310 expny in source; or
2> upon random access problem indication from source MCG MAC; or
2>upon indication from source MCG RLC that the maximum number of retransmissions has been reached:
3> consider radio link failure to be detected for the source MCG i.e. source RLF;
4> suspend all DRBs in the source;
4> release the source connection.
1> else:
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC; that the maximum number of retransmissions has been reached; or
2> if connected as an IAB-node, upon BH RLF indication received on BAP entity from the MCG; or
2> upon indication of consistent uplink LBT failures from MCG MAC;
3> if the indication is from MCG RLC and CA duplication is configured and activated, and for the corresponding logical channel allowedServingCells only includes SCell(s):
4> initiate the failure information procedure to report RLC failure.
3> else:
4> consider radio link failure to be detected for the MCG i.e. RLF;
4> discard any segments of segmented RRC messages received;
4> store the following radio link failure information in the VarRLF-Report by setting its fields as follows:
5> clear the information included in VarRLF-Report, if any;
5> set the plmn-IdentityList to include the list of EPLMNs stored by the UE (i.e. includes the RPLMN);
5> set the measResultLastServCell to include the RSRP, RSRQ and the available SINR, of the source PCell based on the available SSB and CSI-RS measurements collected up to the moment the UE detected radio link failure;
5> set the ssbRLMConfigBitmap and/or csi-rsRLMconfigBitmap in measResultLastServCell to include the radio link monitoring configuration of the source PCell;
5> for each of the configured NR frequencies in which measurements are available:
6> if the SS/PBCH block-based measurement quantities are available:
7> set the measResultListNR in measResultNeighCells to include all the available measurement quantities of the best measured cells, other than the source PCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected radio link failure;
8> for each neighbour cell included, include the optional fields that are available;
6> if the CSI-RS based measurement quantities are available:
7> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSL-RS RSRQ is listed first if CSI-RS RSRQ measurement results are available, otherwise the cell with highest CSI-RS SINR is listed first, based on the available CSI-RS based measurements collected up to the moment the UE detected radio link failure;
8> for each neighbour cell included, include the optional fields that are available;
5> for each of the configured EUTRA frequencies in which measurements are available:
6> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected radio link failure;

NOTE: The measured quantities are filtered by the L3 filter as configured in the mobility measurement configuration. The measurements are based on the time domain measurement resource restriction, if configured. Blacklisted cells are not required to be reported.
5> if detailed location information is available, set the content of locationInfo as follows:
6> if available, set the commonLocationInfo to include the detailed location information;
6> if available, set the bt-LocationInfo in locationInfo to include the Bluetooth measurement results, in order of decreasing RSSI for Bluetooth beacons;
6> if available, set the wlan-LocationInfo in locationInfo to include the WLAN measurement results, in order of decreasing RSSI for WLAN APs;
6> if available, set the sensor-LocationInfo in locationInfo to include the sensor measurement results;
5> set the failedPCellId to the global cell identity and the tracking area code, if available, and otherwise to the physical cell identity and carrier frequency of the PCell where radio link failure is detected;
5> if an RRCRecontiguration message including the reconfigurationWithSync was received before the connection failure:
6> if the last RRCReconfiguration message including the reconfigurationWithSync concerned an intra NR handover;
7> include the previousPCellId and set it to the global cell identity and the tracking area code of the PCell where the last RRCReconfiguration message including reconfigurationWithSync was received;
7> set the timeConnFailure to the elapsed time since reception of the last RRCReconfiguration message including the reconfigurationWithSync;
5> set the connectionFailureType to rlf,
5> set the c-RNTI to the C-RNTI used in the PCell;
5> set the rlf-Cause to the trigger for detecting radio link failure;
5> if the rlf-Cause is set to randomAccessProblem or beamFailureRecoveryFailure:
6> set the absoluteFrequencyPointA to indicate the absolute frequency of the reference resource block associated to the random-access resources;
6> set the locationAndBandwidth and subcarrierSpacing associated to the UL BWP of the random-access resources;
6> set the msgl-FrequencyStart, msgl-FDM and msgl-SubcarrierSpacing associated to the random-access resources;
6> set the parameters associated to individual random-access attempt ire the chronological order of attmepts in the perRAInfoList as follows:
7> if the random-access resource used is associated to a SS/PBCH block, set the associated random-access parameters for the successive random-access attempts associated to the same SS/PBCH block for one or more radom-access attempts as follows:
8> set the ssb-Index to include the SS/PBCH block index associated to the used random-access resource;
8> set the numberOfPreamblesSentOnSSB to indicate the number of successive random access attempts associated to the SS/PBCH block;
8> for each random-access attempt performed on the random-access resource, include the following parameters in the chronological order of the random-access attempt:
9> if contention resolution was not successful for the transmitted preamble:
10> set the contentionDetected to true;
9> else:
10> set the contentionDetected to false;
9> if the SS/PBCH block RSRP of the SS/PBCH block corresponding to the random-access resource used in the random-access attempt is above rsrp-ThresholdSSB:
10> set the dlRSRPAboveThreshold to true;
9> else:
10> set the dlRSRPAboveThreshold to false;
7> else if the random-access resource used is associated to a CSI-RS, set the associated random-access parameters for the successive random-access attempts associated to the same CSI-RS for one or more radorn-access attempts as follows:
8> set the csi-RS-Index to include the CSI-RS index associated to the used random-access resource;
8> set the numberOfPreamblesSentOnCSI-RS to indicate the number of successive random-access attempts associated to the CSI-RS;
8> for each random-access attempt performed on the random-access resource, include the following parameters in the chronological order of the random-access attempt:
9> if contention resolution was not successful for the transmitted preamble:
10> set the contentionDetected to true;
9> else:
10> set the contentionDetected to false;
9> if the CSI-RS RSRP of the CSI-RS corresponding to the random-access resource used in the random-access attempt is above rsrp-ThresholdCSI-RS:
10> se the dlRSRPAboveThreshold to true;
9> else:
10> set the dlRSRPAboveThreshold to false;
4> if AS security has not been activated:
5> perform the actions upon going to RRC_IDLE, with release cause ‘other’;
4> else if AS security has been activated but SRB2 and at least one DRB have not been setup:
5> perform the actions upon going to RRC_IDLE, with release cause ‘RRC connection failure’;
4> else:
5> if T316 is configured; and
5> if SCG transmission is not suspended; and
5> if PSCell change is not ongoing (i.e. timer T304 for the NR PSCell is not running in case of NR-DC or timer T307 of the E-UTRA PSCell is not running in NE-DC):
6> initiate the MCG failure information procedure to report MCG radio link failure.
5> else:
6> initiate the connection re-establishment procedure

The UE may discard the radio link failure information, i.e. release the UE variable VarRLF-Report, 48 hours after the radio link failure is detected.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF failure indication received on BAP entity from the SCG;
1> upon indication of consistent uplink LBT failures from SCG MAC:
2> if the indication is from SCG RLC and CA duplication is configured and activated; and for the corresponding logical channel allowedServingCells only includes SCell(s):
3> initiate the failure information procedure to report RLC failure.
2> else if MCG transmission is not suspended:
3> consider radio link failure to be detected for the SCG, i.e. SCG RLF;
3> initiate the SCG failure information procedure to report SCG radio link failure.
2> else:
3> if the UE is in NR-DC:
4> initiate the connection re-establishment procedure;
3> else (the UE is in (NG)EN-DC):
4> initiate the connection re-establishment procedure;

Non-terrestrial networks (NTN) in 5G NR is described. Sections 3, 4, and 8.7 of 3GPP TR 38.821 V16.0.0 (2020-01) can be referred.

NTN means networks, or segments of networks, using an airborne or space-borne vehicle to embark a transmission equipment relay node or base station. In NTN, the following terms may be used.

Feeder link: Wireless link between NTN Gateway and satellite

Geostationary Earth orbit: Circular orbit at 35,786 km above the Earth's equator and following the direction of the Earth's rotation. An object in such an orbit has an orbital period equal to the Earth's rotational period and thus appears motionless, at a fixed position in the sky, to ground observers.

Low Earth Orbit: Orbit around the Earth with an altitude between 300 km, and 1500 km.

Medium Earth Orbit: region of space around the Earth above low Earth orbit and below geostationary Earth Orbit.

Minimum Elevation angle: minimum angle under which the satellite or UAS platform can be seen by a terminal.

Mobile Services: a radio-communication service between mobile and land stations, or between mobile stations

Mobile Satellite Services: A radio-communication service between mobile earth stations and one or more space stations, or between space stations used by this service; or between mobile earth stations by means of one or more space stations

Non-Geostationary Satellites: Satellites (LEO and MEO) orbiting around the Earth with a period that varies approximately between 1.5 hour and 10 hours. It is necessary to have a constellation of several Non-Geostationary satellites associated with handover mechanisms to ensure a service continuity.

Non-terrestrial networks: Networks, or segments of networks, using an airborne or space-borne vehicle to embark a transmission equipment relay node or base station.

NTN-gateway: an earth station or gateway is located at the surface of Earth, and providing sufficient RF power and RF sensitivity for accessing to the satellite (resp. HAPS), NTN Gateway is a transport network layer (TNL) node.

On Board processing: digital processing carried out on uplink RF signals aboard a satellite or an aerial.

On board NTN gNB: gNB implemented in the regenerative payload on board a satellite (respectively HAPS).

On ground NTN gNB: gNB of a transparent satellite (respectively HAPS) payload implemented on ground.

One-way latency: time required to propagate through a telecommunication system from a terminal to the public data network or from the public data network to the terminal. This is especially used for voice and video conference applications.

Regenerative payload: payload that transforms and amplifies an uplink RF signal before transmitting it on the downlink. The transformation of the signal refers to digital processing that may include demodulation, decoding, re-encoding, re-modulation and/or filtering.

Round Trip Delay: time required for a signal to travel from a terminal to the sat-gateway or from the sat-gateway to the terminal and back. This is especially used for web-based applications.

Satellite: a space-home vehicle embarking a bent pipe payload or a regenerative payload telecommunication transmitter, placed into Low-Earth Orbit (LEO), Medium-Earth Orbit (MEO), or Geostationary Earth Orbit (GEO).

Satellite beam: A beam generated by an antenna on-board a satellite

Service link: Radio link between satellite and UE

Transparent payload: payload that changes the frequency carrier of the uplink RF signal, filters and amplifies it before transmitting it on the downlink

Unmanned Aircraft Systems: Systems encompassing Tethered UAS (TUA), Lighter Than Air UAS (LTA), Heavier Than Air UAS (HTA), all operating in altitudes typically between 8 and 50 km including High Altitude Platforms (HAPs)

User Connectivity: capability to establish and maintain data/voice/video transfer between networks and Terminals

User Throughput: data rate provided to a terminal

A non-terrestrial network refers to a network, or segment of networks using RF resources on board a satellite (or LAS platform).

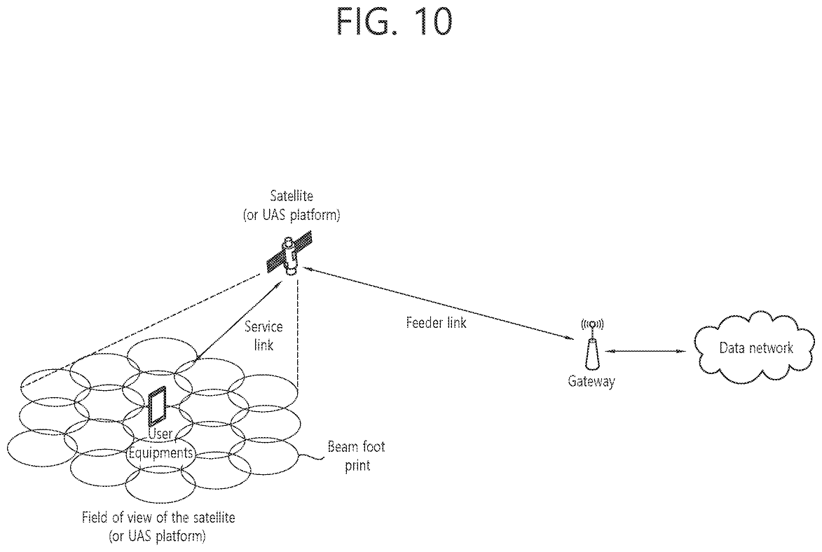

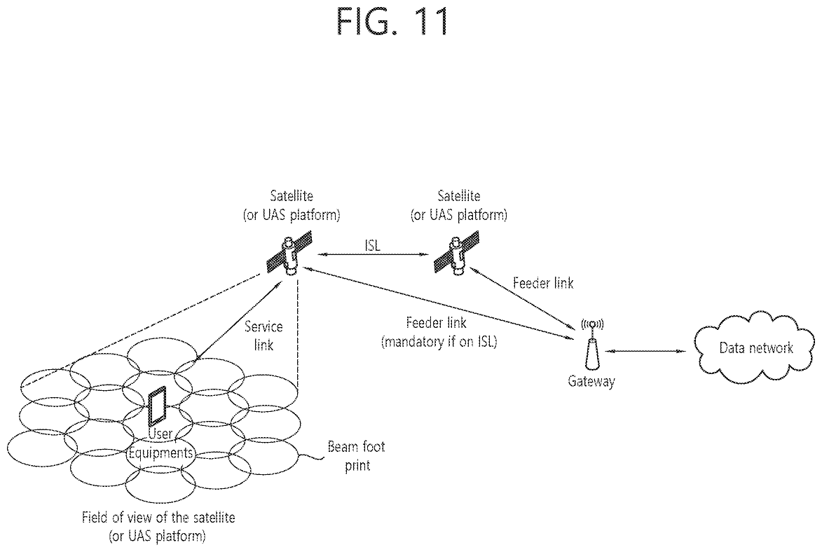

FIG. 10 and FIG. 11 show typical scenarios of a non-terrestrial network providing access to user equipment to which implementations of the present disclosure is applied.

In particular, FIG. 10 illustrates an example of non-terrestrial network typical scenario based on transparent payload. FIG. 11 illustrates an example of non-terrestrial network typical scenario based on regenerative payload

Non-Terrestrial Network typically features the following elements:
One or several sat-gateways that connect the Non-Terrestrial Network to a public data network
a GEO satellite is fed by one or several sat-gateways which are deployed across the satellite targeted coverage (e.g. regional or even continental coverage). We assume that UE in a cell are served by only one sat-gateway
A Non-GEO satellite served successively by one or several sat-gateways at a time. The system ensures service and feeder link continuity between the successive serving sat-gateways with sufficient time duration to proceed with mobility anchoring and hand-over
A Feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio Frequency filtering, Frequency conversion and amplification. Hence, the waveform signal repeated by the payload is un-changed;
A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment are served by the satellite (or UAS platform) within the targeted service area.

Table 5 shows types of NTN platforms. For example, there may be different types of satellites (or UAS platforms).

TABLE 5

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | notional station keeping | 200-3500 | km |
| Orbit | | | position fixed in terms of | | |
| (GEO) satellite | | | elevation/azimuth with respect | | |
| UAS platform | 8-50 | km | to a given earth point | | |
| (including HAPS) | (20 km for HAPS) | | | 5-200 | km |
| High Elliptical Orbit | 400-50000 | km | Elliptical around the earth | 200-3500 | km |
| (HEO) satellite | | | | | |

GEO satellite and Unmanned Aircraft System (UAS) are used to provide continental, regional or local service. A constellation of LEO and MEO is used to provide services in both Northern and Southern hemispheres. In some case, the constellation can even provide global coverage including polar regions. For the later, this requires appropriate orbit inclination, sufficient beams generated and inter-satellite links.

HEO satellite systems are not considered in this document.

Operations related to feeder link switch over are described.

During NTN operation, it may become necessary to switch the feeder link (SRI) between different NTN GWs toward the same satellite. This may be due to e.g. maintenance, traffic offloading, or (for LEO) due to the satellite moving out of visibility with respect to the current NTN GW. The switchover should be performed without causing service disruption to the served UEs. This can be done in different ways according to the NTN architecture option deployed.

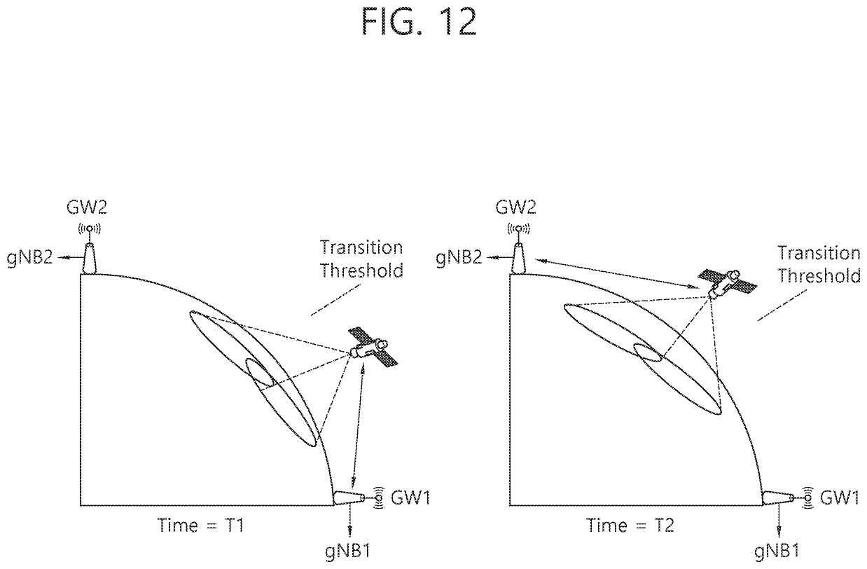

FIG. 12 shows an example of the feeder link switch for transparent LEO to which implementations of the present disclosure is applied.

Referring to FIG. 12, in the transparent case, the gNB is on earth thus there will be a switch from gNB1 to gNB2. If the satellite can be served by one feeder link at a time it means that with Rel-15 NR assumptions the RRC connection for all UEs served by the gNB1 (via GW1) needs to be dropped. After gNB2 (via GW2) takes over, the UEs may be able to find the reference signals corresponding to gNB2 and perform initial access on a cell belonging to gNB2.

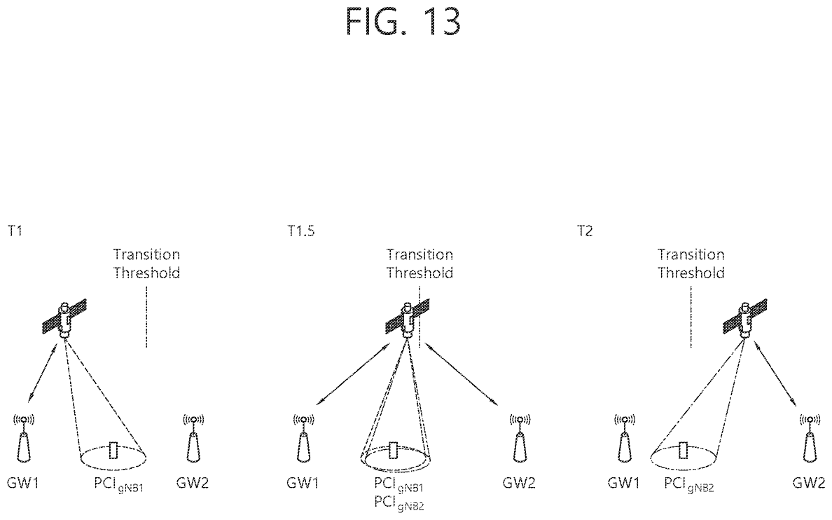

FIG. 13 shows one possible solution to enable service continuity for feeder link switch to which implementations of the present disclosure is applied.

Referring to FIG. 13, at time T1, the satellite is approaching the geographical location where the transition to be served by next OW will happen. At time T1.5, the satellite is served by two GWs and at time T2 the transition to next GW is finished.

Assuming two feeder link connections serving via the same satellite during the transition (time T1.5 in FIG. 13), there exists a HO based solution that should be feasible with Rel-15 or close to Rel-15 assumptions. This assumes that it is possible to represent cells of two different gNBs over a given area via the same satellite but via different NTN-GWs. The two gNBs may utilize different radio resources of the transparent satellite to ensure both gNBs are visible to the UE (overlapping coverage areas) simultaneously. During the switch, the gNB2 which serves the satellite via GW2 may start transmitting the CD-SSBs of its cells on synchronization raster points that are different from those of the gNB1. UEs could be have a HO from PCI belonging to gNB1 to PCI belonging to gNB2. This could be a blind HO (network decision without measurement) or assisted with measurements. Alternatively, the gNB1 may be present for a first time-period and configure a conditional handover to the gNB2, after which the gNB2 is available for a second time-period where the UEs can then perform the radio handover. Furthermore, the mobility solution may need to also mitigate for the fact that the UEs may observe very similar RSRP/RSRQ of the service links, provided by the source and target gNBs, because the reference signals are transmitted from the same satellite. One solution may be left to network implementation, e.g. setting proper event A5 thresholds for conditional handover to enable handover, or to rely on radio propagation time instead or in combination with the RSRP/RSRQ radio measurements. Relying on radio propagation time includes to take the RTT experienced by the UE into account in handover decisions. Either as condition in CHO or in network HO decision.

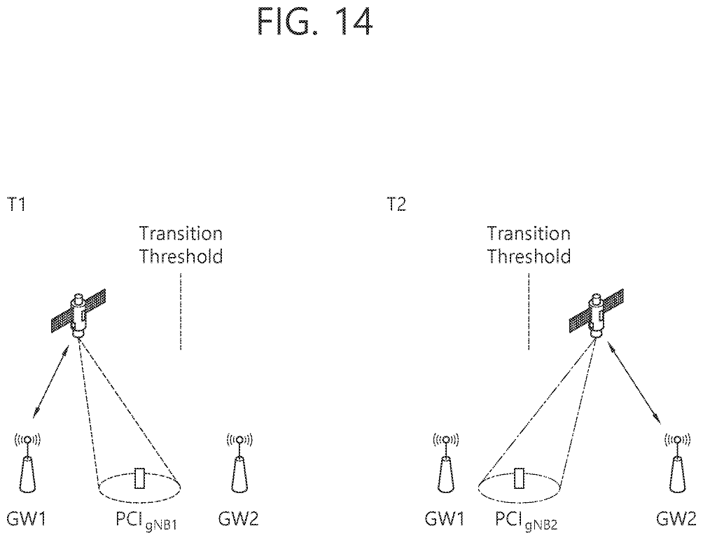

FIG. 14 shows another possible solution to enable service continuity for feeder link switch to which implementations of the present disclosure is applied.

At time T1, the satellite stops to transfer the signalling from the serving GW1. At time T2, the satellite starts to transfer the signalling from the target GW2.

Assuming only one feeder link connection serving via the same satellite is applicable during the transition, which means the signal of the serving cell will be not available during time T1 to time T2. To make the UE access to the serving cell again, two potential options are listed below:

Solution 1: Feeder link hard switch procedure is based on accurate time control

Assuming the old feeder link serves the satellite until to T1 and the new feeder link begins to serve the satellite from T2. This assumes that the cells of the source gNB(s) are represented over a given area at any time before T1, and the new cells of the target gNB(s) are represented from time T2.

As there's no overlap of source cells and target cells from the gNB(s) located at the old and the new NTN GWs, the switch over relies on accurate time control. The handover command should be sent to all the UEs before T1, e.g. CHO. The UE should not initiate the handover procedure immediately upon receiving the Handover Command, instead, UE should initiate the handover procedure after T2, and thus an activation time should be included in the handover command to all the connected UEs.

Solution 2: Feeder link hard switch procedure is based on conditional RRC re-establishment

Considering the large cell size of NTN, it might be an extremely difficult problem for gNB1 to send HO commands to a large number of UEs respectively in a short time. A part of UEs may not be able to perform HO in time, as a result, radio link failure may be detected and then UEs initiate the RRC reestablishment procedure. It will take a long time to restore RRC connection, which may involve RLF detection, cell selection and potential reestablishment failure, as a result it has an influence on the service continuity. Thus it may be beneficial for network to provide assistance information (e.g. next cell identity and/or reestablishment conditions) to trigger UE RRC reestablishment instead. Besides, the assistance information can be sent to UE via SIB instead of dedicated signalling respectively, as a result, the signalling overhead caused by the large number of UEs can be effectively reduced.

As described above, during NTN operation, feeder link switching between different NTN gateways toward the same satellite could be performed. For example, the feeder link switching may occur because of system maintenance, data offloading, and/or movement by Low Earth Orbit (LEO) satellites. If an LEO satellite is moving out of visibility with respect to the current NTN gateway, the LEO satellite may find new NTN gateway to serve. This switching procedure may need to be performed without causing service disruption to the served UEs.

However, considering a large cell coverage size of NTN, it might be an extremely difficult for NTN gateway to send HO commands to the large number of served UEs via satellites respectively in a short time. For example, a part of UEs may not be able to perform handover or receive handover configuration in time. As a result, radio link failure may be detected for the part of UEs, and then UEs may need to perform a RRC restoring procedure.

Since it may take a long time to restore RRC connection, which may involve RLF detection, cell selection, and potential reestablishment failure, it may cause a problem with service continuity.

Therefore, studies for pausing Radio Link Failure detection for Non-Terrestrial Networks are required.

Hereinafter, a method for pausing Radio Link Failure detection for Non-Terrestrial Networks, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

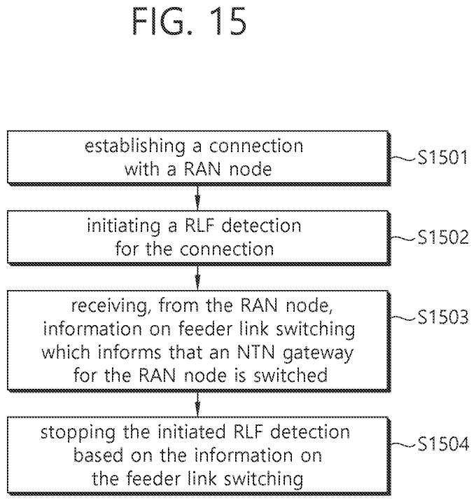

FIG. 15 shows an example of a method for pausing Radio Link Failure detection for Non-Terrestrial Networks, according to some embodiments of the present disclosure.

In particular, FIG. 15 shows an example of a method performed by a wireless device in a wireless communication system.

In step S1501, a wireless device may establish a connection with a Radio Access Node (RAN) node.

For example, the RAN node may include a satellite and the NTN gateway. A wireless link between the NTN gateway and the satellite may be a feeder link. A radio link between the wireless device and the satellite may be a service link.

For example, a RAN node may he associated with an NTN cell.

In step S1502, a wireless device may initiate a Radio Link Failure (RLF) detection for the connection;

For example, a wireless device may receive a RLF configuration related to the RLF detection. The RLF configuration may include information on (i) an RLF timer to declare the RLF, and/or (ii) a maximum number of consecutive out-of-sync indications to start the RLF timer.

In step S1503, a wireless device may receive, from the RAN node, information on feeder link switching which informs that an NTN gateway for the RAN node is switched.

For example, the feeder link switching may include changing the feeder link between the satellite and the NTN gateway to another feeder link between the satellite and another NTN gateway.

For example, the RAN node may provide the information on the feeder link switching, when the feeder link switching is performed. When the feeder link switching is performed, serving NTN gateway of satellite may be changed.

For example, the information on the feeder link switching may include an information for (i) pausing of the RLF detection, (ii) stopping of the RLF detection, and/or (iii) relaxing of the RLF detection.

For example, the information on the feeder link switching may be provided via dedicated signalling, for example, an RRCReconfiguration message and/or an RRCRelease message.

For example, the information on the feeder link switching may be provided via broadcast signalling, for example, a system information and/or a paging message.

According to some embodiments of the present disclosure, the information on the feeder link switching may include a timer value to stop the REF detection for step S1504. In this case, the wireless device may stop the RLF detection for a duration corresponding to the time value. For example, the wireless device may restart the stepped RLF detection after the duration corresponding to the time value. For other example, the wireless device may start another RLF detection after the duration corresponding to the time value.

In step S1504, a wireless device may stop the initiated RLF detection based on the information on the feeder link switching.

For example, the wireless device may stop the RLF detection upon receiving the information on the feeder link switching.

For example, if the timer value is included in the information on the feeder link switching, the wireless device may start a timer corresponding to the timer value, upon stopping the initiated RLF detection.

According to some embodiments of the present disclosure, the RLF detection may include counting out-of-sync indications. For example, the out-of-sync indications may be received by an upper layer (for example, an RRC layer) of the wireless device from a lower layer (for example, a PHY layer) of the wireless device.

In this case, the wireless device may stop the initiated RLF detection by pausing to count a number of out-of-sync indications. For example,

According to some embodiments of the present disclosure, the RLF detection may include counting out-of-sync indications. For example, the out-of-sync indications may be received by an upper layer (for example, an RRC layer) of the wireless device from a lower layer (for example, a PHY layer) of the wireless device.

In this case, the wireless device may stop the initiated RLF detection by pausing to count a number of out-of-sync indications.

For example, the wireless device may count the number of out-of-sync indications from the paused number, when the wireless device restarts the RLF detection. For other example, the wireless device may count the number of out-of-sync indications from beginning, when the wireless device restarts the RLF detection.

According to some embodiments of the present disclosure, the RLF detection may include starting an RLF timer based on that a number of consecutive out-of-sync indications reaches a maximum number. For example, a wireless device may declare the RLF timer upon expiry of the RLF timer. For example, a wireless device may stop the RLF timer upon receiving an in-sync indication.

In this case, the wireless device may stop the initiated RLF detection by pausing the started RLF timer.

For example, the wireless device may restart the paused RLF timer from the paused moment, when the wireless device restarts the RLF detection. For other example, the wireless device may restart the RLF timer from beginning, when the wireless device restarts the RLF detection.

According to some embodiments of the present disclosure, the RLF detection may include detecting that a maximum number of retransmissions has been reached.

For example, an RLC layer of the wireless device may detect that a maximum number of retransmissions has been reached. When the RLC layer detects that a maximum number of retransmissions has been reached, the RLC layer of the wireless device may report to the RRC layer.

In this case, the wireless device may stop the initiated RLF detection by pausing to count a number of retransmissions.

For example, the wireless device may count the number of retransmissions from the paused number, when the wireless device restarts the RLF detection. For other example, the wireless device may count the number of retransmissions from beginning, when the wireless device restarts the RLF detection.

According to some embodiments of the present disclosure, the RLF detection may include receiving indication of consistent uplink LBT failures. For example, the indication of consistent uplink LBT failures may be received by an RRC layer of the wireless device from a MAC layer of the wireless device.

In this case, the wireless device may stop the initiated RLF detection by pausing to count a number of the indication of consistent uplink LBT failures.

After step S1504, a wireless device may restart the RLF detection.

According to some embodiments of the present disclosure, a wireless device may restart the RLF detection, when the wireless device receives, from a network (for example, the RAN node with the switched feeder link and the switched NTN gateway), an information informing that the feeder link switching is completed.

For example, a wireless device may receive, from the network, an information to restart the RLF detection.

For example, the information on the completeness of the feeder link switching may include the information to restart the RLF detection.

For example, the information on the completeness of the feeder link switching may be provided via dedicated signalling and/or broadcast signalling.

According to some embodiments of the present disclosure, a wireless device may restart the RLF detection, when a timer, corresponding to a time value received from step S1503, expires.

According to some embodiments of the present disclosure, for example, upon restarting the RLF detection, the wireless device may restart the paused RLF detection from the paused moment.

For example, the wireless device may restart to count a number of out-of-sync indications from the paused number.

For example, the wireless device may restart the RLF timer from the paused moment.

For example, the wireless device may restart to count a number of retransmissions from the paused number.

According to some embodiments of the present disclosure, for example, upon restarting the RLF detection, the wireless device may restart the paused RLF detection from beginning.

For example, the wireless device may restart to count a number of out-of-sync indications from beginning.

For example, the wireless device may restart the RLF timer from beginning.

For example, the wireless device may restart to count a number of retransmissions from beginning.

According to some embodiments of the present disclosure, the wireless device may be in communication with at least one of a user equipment, a network, or an autonomous vehicle other than the wireless device.

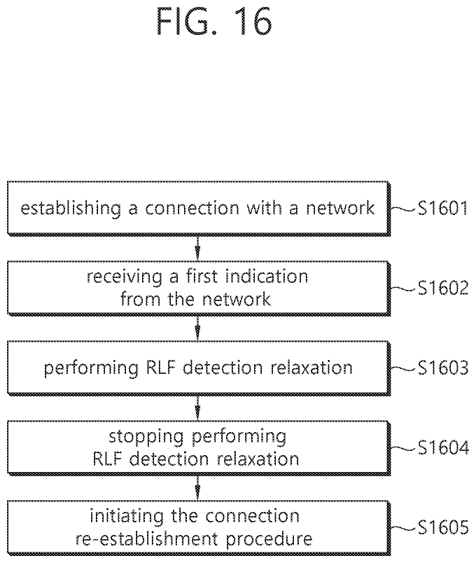

FIG. 16 shows an example of a method for pausing Radio Link Failure detection for Non-Terrestrial Networks, according to some embodiments of the present disclosure.

According to some embodiments of the present disclosure, a network may provide a first indication to UEs when the network (for example, serving satellite) is going to perform feeder link switching so that temporary radio link failure is expected. Upon receiving the first indication which optionally includes timer, UE may not declare RLF for a time period.

After a second indication is received and/or the time period is elapsed based on the timer, the UE may evaluate conditions for RLF declaration and declare RLF when the RLF condition is met. Based on the first/second indication, UE can avoid triggering unnecessary re-establishment procedure when it relaxes conditions of RLF declaration.

Referring to FIG. 16, in step S1601, a UE may establish a connection with a network.

For example, the network may include satellite and NTN gateway (for example, as described in FIGS. 10 and 11). Radio link between UE and satellite may be service link and radio link between NTN gateway and satellite may be feeder link.

In step S1602, the UE may receive a first indication from the network.

For example, the network may provide the first indication when feeder link switching is performed. When feeder link switching is performed, serving NTN gateway of satellite may be changed.

For example, the first indication may indicate to perform RLF detection relaxation.

For example, the first indication may include a timer value.

For example, the first indication may be provided via dedicated signalling (for example, RRCReconfiguration, RRCRelease).

For example, the first indication may be provided via broadcast signalling (for example, system information and/or paging)

In step S1603, the UE may perform RLF detection relaxation.

For example, the UE may perform RLF detection relaxation based on the first indication received in step S1602.

For example, when the UE starts to perform RLF detection relaxation, if the timer value is provided in step S1602, the UE may start a timer with the given timer value. Then the UE may perform RLF detection relaxation until the tinier expires. After the timer expires, the UE may stop performing RLF detection relaxation.

According to some embodiments of the present disclosure, while UE is performing RLF detection relaxation, the UE may perform at least one of the followings:
The UE may not count consecutive “out-of-sync” indications for the source. If UE RRC receives the “out-of-sync” indications for the source from lower layers, the UE RRC may not include the indication into the consecutive “out-of-sync” indication,
The UE may not consider radio link failure to be detected for the MCG (for example, RLF), even if UE RRC receives random access problem indication from MCG MAC.
The UE may not consider radio link failure to be detected for the source MCG (for example, source RLF), even if UE RRC receives indication from MCG RLC that the maximum number of retransmissions has been reached.
The UE may not consider radio link failure to be detected for the MCG (for example RLF), even if UE RRC receives indication of consistent uplink LBT failures from MCG MAC.
The UE may not store any radio link failure information, for example, in the VarRLF-Report.

In step S1604, the UE may stop performing RLF detection relaxation, when at least one of the conditions is met:
When the UE receives a second indication from the network to stop performing RLF detection relaxation.

For example, the second indication may indicate stop of RLF detection relaxation.

For example, the second indication may be provided via dedicated signalling.

For example, the second indication may be provided via broadcast signalling (for example, system information and/or paging).
When the timer started in step S1603 expires.

According to some embodiments of the present disclosure, when RLF detection relaxation is stopped, the UE may perform at least one of the actions:
The UE may start a timer for the source upon receiving any “out-of-sync” indications for the source from lower layers.

For example, the timer may be T310.
The UE may start a timer for the source upon receiving consecutive “out-of-sync” indications for the source from lower layers.

For example, the timer may be T310.

For example, the consecutive “out-of-sync” indication may be N310 consecutive “out-of-sync” indications.
The UE may consider radio link failure for the MCG (for example, RLF) to be detected, if UE RRC receives random access problem indication from MCG MAC.
The UE may consider radio link failure for the MCG (for example, RLF) to be detected, if UE RRC receives indication from MCG RLC that the maximum number of retransmissions has been reached.
The UE may consider radio link failure to be detected for the MCG (for example, RLF), if UE RRC receives indication of consistent uplink LBT failures from MCG MAC.
The UE may store any radio link failure information e.g. in the VarRLF-Report

In step S1605, when it is considered that radio link failure to be detected, the UE may initiate the connection re-establishment procedure.

According to some embodiments of the present disclosure, a wireless device (for example, a UE) may establish a connection with a network related to non-terrestrial network. A wireless device may receiving, from the network, an indication and information on a timer. The indication may indicate not to count “out-of-sync” indications received from lower layer while the timer is running. A wireless device may start timer. A wireless device may count number of “out-of-sync” indications received from the lower layer, after the timer expires. A wireless device may performing RRC Re-establishment procedure upon that the counted number of “out-of-sync” indications exceeds a configured value.

Hereinafter, an apparatus for pausing Radio Link Failure detection for Non-Terrestrial Networks, according to some embodiments of the present disclosure, will be described. Herein, the apparatus may be a wireless device (100 or 200) in FIGS. 2, 3, and 5.

For example, a wireless device may perform methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to establish a connection with a Radio Access Node (RAN) node. The processor 102 may be configured to initiate a Radio Link Failure (RLF) detection for the connection. The processor 102 may be configured to control the transceiver 106 to receive, from the RAN node, information on feeder link switching which informs that an NTN gateway for the RAN node is switched. The processor 102 may be configured to stop the initiated RLF detection based on the information on the feeder link switching.

For example, the processor 102 may be configured to control the transceiver 106 to receive a RLF configuration related to the RLF detection.

For example, the RLF configuration may include information on (i) an RLF timer to declare the RLF, and/or (ii) a maximum number of consecutive out-of-sync indications to start the RLF timer.

According to some embodiments of the present disclosure, the RLF detection may include counting out-of-sync indications.

In this case, the step of stopping the initiated RLF detection may include pausing to count a number of out-of-sync indications.

For example, the out-of-sync indications may be received, by an upper layer of the wireless device, from a lower layer of the wireless device.

According to some embodiments of the present disclosure, the RLF detection may include starting an RLF timer based on that a number of consecutive out-of-sync indications reaches a maximum number.

For example, the RLF detection may include declaring the RLF timer upon expiry of the RLF timer.

In this case, the step of stopping the initiated RLF detection may include pausing the started RLF timer.

According to sonic embodiments of the present disclosure, the RLF detection may include detecting that a maximum number of retransmissions has been reached.

In this case, the step of stopping the initiated RLF detection includes pausing to count a number of retransmissions.

According to some embodiments of the present disclosure, the RAN node may include a satellite and the NTN gateway. A feeder link may be a wireless link between the NTN gateway and the satellite.

The feeder link switching may include changing the feeder link between the satellite and the NTN gateway to another feeder link between the satellite and another NTN gateway.

According to some embodiments of the present disclosure, the processor 102 may be configured to he in communication with at least one of a user equipment, a network, or an autonomous vehicle other than the wireless device.

Hereinafter, a processor for a wireless device for pausing Radio Link Failure detection for Non-Terrestrial Networks, according to some embodiments of the present disclosure, will be described.

The processor may be configured to control the wireless device to establish a connection with a Radio Access Node (RAN) node. The processor may be configured to control the wireless device to initiate a Radio Link Failure (RLF) detection for the connection. The processor may be configured to control the wireless device to receive, from the RAN node, information on feeder link switching which informs that an NTN gateway for the RAN node is switched. The processor may be configured to control the wireless device to stop the initiated RLF detection -based on the information on the feeder link switching.

For example, the processor may be configured to control the wireless device to receive a RLF configuration related to the RLF detection.

For example, the RLF configuration may include information on (i) an RLF timer to declare the RLF, and/or (ii) a maximum number of consecutive out-of-sync indications to start the RLF timer.

According to some embodiments of the present disclosure, the RLF detection may include counting out-of-sync indications.

In this case, the step of stopping the initiated RLF detection may include pausing to count a number of out-of-sync indications.

For example, the out-of-sync indications may be received, by an upper layer of the wireless device, from a lower layer of the wireless device.

According to some embodiments of the present disclosure, the RLF detection may include starting an RLF timer based on that a number of consecutive out-of-sync indications reaches a maximum number.

For example, the RLF detection may include declaring the RLF timer upon expiry of the RLF timer.

In this case, the step of stopping the initiated RLF detection may include pausing the started RLF timer.

According to some embodiments of the present disclosure, the RLF detection may include detecting that a maximum number of retransmissions has been reached.

In this case, the step of stopping the initiated RLF detection includes pausing to count a number of retransmissions.

According to some embodiments of the present disclosure, the RAN node may include a satellite and the NTN gateway. A feeder link may be a wireless link between the NTN gateway and the satellite.

The feeder link switching may include changing the feeder link between the satellite and the NTN gateway to another feeder link between the satellite and another NTN gateway.

According to some embodiments of the present disclosure, the processor may be configured to control the wireless device to be in communication with at least one of a user equipment, a network, or an autonomous vehicle other than the wireless device.

Hereinafter, a non-transitory computer-readable medium has stored thereon a plurality of instructions for pausing Radio Link Failure detection for Non-Terrestrial Networks, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to establish a connection with a Radio Access Node (RAN) node. The stored a plurality of instructions may cause the wireless device to initiate a Radio Link Failure (RLF) detection for the connection. The stored a plurality of instructions may cause the wireless device to receive, from the RAN node, information on feeder link switching which informs that an NTN gateway for the RAN node is switched. The stored a plurality of instructions may cause the wireless device to stop the initiated RLF detection based on the information on the feeder link switching.

For example, the stored a plurality of instructions may cause the wireless device to receive a RLF configuration related to the RLF detection.

For example, the RLF configuration may include information on (i) an RLF timer to declare the RLF, and/or (ii) a maximum number of consecutive out-of-sync indications to start the RLF timer.

According to some embodiments of the present disclosure, the RLF detection may include counting out-of-sync indications.

In this case, the step of stopping the initiated RLF detection may include pausing to count a number of out-of-sync indications.

For example, the out-of-sync indications may be received, by an upper layer of the wireless device, from a lower layer of the wireless device.

According to some embodiments of the present disclosure, the RLF detection may include starting an RLF timer based on that a number of consecutive out-of-sync indications reaches a maximum number.

For example, the RLF detection may include declaring the RLF timer upon expiry of the RLF timer.

In this case, the step of stopping the initiated RLF detection may include pausing the started RLF timer.

According to some embodiments of the present disclosure, the RLF detection may include detecting that a maximum number of retransmissions has been reached.

In this case, the step of stopping the initiated RLF detection includes pausing to count a number of retransmissions.

According to some embodiments of the present disclosure, the RAN node may include a satellite and the NTN gateway. A feeder link may be a wireless link between the NTN gateway and the satellite.

The feeder link switching may include changing the feeder link between the satellite and the NTN gateway to another feeder link between the satellite and another NTN gateway.

According to some embodiments of the present disclosure, the stored a plurality of instructions may cause the wireless device to be in communication with at least one of a user equipment, a network, or an autonomous vehicle other than the wireless device.

Hereinafter, a method performed by a Radio Access Network (RAN) node for pausing Radio Link Failure detection for Non-Terrestrial Networks, according to some embodiments of the present disclosure, will be described.

The RAN node may transmit, to a wireless device, information on feeder link switching which informs that an NTN gateway for the RAN node is switched. The RAN node may transmit, to the wireless device, information informing that the feeder link switching is completed.

Hereinafter, a Radio Access Network (RAN) node for pausing Radio Link Failure detection for Non-Terrestrial Networks, according to some embodiments of the present disclosure, will be described.

The RAN node may include a transceiver, a memory, and a processor operatively coupled to the transceiver and the memory.

The processor may be configured to control the transceiver to transmit, to a wireless device, information on feeder link switching which informs that an NTN gateway for the RAN node is switched. The processor may be configured to control the transceiver to control the transceiver to transmit, to the wireless device, information informing that the feeder link switching is completed.

The present disclosure can have various advantageous effects.

According to some embodiments of the present disclosure, a wireless device could efficiently pause Radio Link Failure detection for Non-Terrestrial Networks.

For example, a wireless device could relax the RLP condition temporarily, by receiving information from the network.

For example, a wireless device could avoid unnecessary RLF declaration or triggering re-establishment procedure can be avoided, by pausing the RLF detection temporarily.

According to some embodiments of the present disclosure, a wireless communication system could provide a solution for pausing Radio Link Failure detection for Non-Terrestrial Networks efficiently.

For example, when network expects that the radio link will be temporarily unavailable so that temporary RLF may occur, the network may inform wireless devices to relax the RLF detection condition temporarily.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a wireless device in a wireless communication system, the method comprising,
establishing a connection with a Radio Access Node (RAN) node;
initiating a Radio Link Failure (RLF) detection for the connection;
receiving, from the RAN node, information related to a feeder link between a non-terrestrial networks (NTN) gateway and the RAN node; and
stopping the initiated RLF detection based on the information related to the feeder link.

2. The method of claim 1, wherein the method further comprises,
receiving a RLF configuration related to the RLF detection.

3. The method of claim 2, wherein the RLF configuration includes information on (i) an RLF timer to declare the RLF, and/or (ii) a maximum number of consecutive out-of-sync indications to start the RLF timer.

4. The method of claim 1, wherein the RLF detection includes counting out-of-sync indications.

5. The method of claim 4, wherein the step of stopping the initiated RLF detection includes pausing to count a number of out-of-sync indications.

6. The method of claim 4, wherein the out-of-sync indications are received, by an upper layer of the wireless device, from a lower layer of the wireless device.

7. The method of claim 1, wherein the RLF detection includes starting an RLF timer based on that a number of consecutive out-of-sync indications reaches a maximum number.

8. The method of claim 7, wherein the RLF detection includes declaring the RLF timer upon expiry of the RLF timer.

9. The method of claim 7, wherein the step of stopping the initiated RLF detection includes pausing the started RLF timer.

10. The method of claim 1, wherein the RLF detection includes detecting that a maximum number of retransmissions has been reached.

11. The method of claim 10, wherein the step of stopping the initiated RLF detection includes pausing to count a number of retransmissions.

12. The method of claim 1, wherein the RAN node includes a satellite.

13. The method of claim 12, wherein the feeder link switching includes changing the feeder link between the satellite and the NTN gateway to another feeder link between the satellite and another NTN gateway.

14. The method of claim 1, wherein the wireless device is in communication with at least one of a user equipment, a network, or an autonomous vehicle other than the wireless device.

15. A wireless device configured to operate in a wireless communication system, the wireless device comprising:
a transceiver;
a memory; and
at least one processor operatively coupled to the transceiver and the memory, and configured to:
establish a connection with a Radio Access Node (RAN) node;
initiate a Radio Link Failure (RLF) detection for the connection;
control the transceiver to receive, from the RAN node, information related to a feeder link between a non-terrestrial networks (NTN) gateway and the RAN node; and
stop the initiated RLF detection based on the information related to the feeder link.

16. The wireless device of claim 15, wherein the at least one processor is further configured to, control the transceiver to receive a RLF configuration related to the RLF detection.

17. The wireless device of claim 16, wherein the RLF configuration includes information on (i) an RLF timer to declare the RLF, and/or (ii) a maximum number of consecutive out-of-sync indications to start the RLF timer.

18. The wireless device of claim 15, wherein the RLF detection includes counting out-of-sync indications.

19-31. (canceled)

32. A base station configured to operate in a wireless communication system, the base station comprising:
a transceiver;
a memory; and
a processor operatively coupled to the transceiver and the memory, and configured to:
control the transceiver to transmit, to a wireless device, information on feeder link switching which informs that a non-terrestrial networks (NTN) gateway for a Radio Access Node (RAN) node is switched; and
control the transceiver to transmit, to the wireless device, information informing that the feeder link switching is completed.

33. The method of claim 1,
wherein the information related to the feeder link includes switching information which informs that the NTN gateway for the RAN node is switched to another NTN gateway.
